(19) United States
(12) Patent Application Publication
(10) Pub. No.: US 2025/0245840 A1
(43) Pub. Date: Jul. 31, 2025

(54) DETERMINING MOTION USING MONOCULAR DEPTH ESTIMATION

(71) Applicant: Toyota Research Institute, Inc., Los Altos, CA (US)

(72) Inventor: Vitor Campagnolo Guizilini, Santa Clara, CA (US)

(73) Assignees: Toyota Research Institute, Inc., Los Altos, CA (US); Toyota Jidosha Kabushiki Kaisha, Toyota-shi Aichi-ken (JP)

(21) Appl. No.: 18/426,933

(22) Filed: Jan. 30, 2024

(51) Int. Cl. G06T 7/246; G06T 7/50

(52) U.S. Cl. CPC G06T 7/248; G06T 7/50; G06T 2207/20081

(57) ABSTRACT

Systems, methods, and other embodiments described herein relate to determining motion from images with the use of monocular depth estimation. In one embodiment, a method includes acquiring images depicting surrounding objects present in an environment. The method includes generating depth maps for the images according to a depth model that performs monocular depth estimation. The method includes generating an indicator about motion associated with the surrounding objects according to the depth maps. The method includes providing the indicator about motion.

### TECHNICAL FIELD

The subject matter described herein relates, in general, to systems and methods for determining motion from images and, more particularly, to using monocular depth estimation to derive maps using the images from which estimates of motion are generated.

### BACKGROUND

Various devices that operate autonomously or that provide information about a surrounding environment use sensors that facilitate perceiving obstacles and additional aspects of the surrounding environment. For example, a robotic device may use information from the sensors to develop an awareness of the surrounding environment in order to navigate through the environment. In particular, the robotic device uses the perceived information to determine a 3-D structure of the environment in order to identify navigable regions and avoid potential hazards.

The ability to perceive different aspects of the surrounding environment, such as distances, movement, and so on, provides the robotic device with the ability to plan movements through the environment and generally improves situational awareness about the environment. However, depending on the available onboard sensors, the robotic device may acquire a limited perspective of the environment and, thus, encounter difficulties in distinguishing aspects of the environment. For example, while monocular cameras can be a cost-effective approach to acquiring information about the surroundings, the sensor data from such cameras does not explicitly include depth information nor explicit information about motion as may be provided by a radar. Accordingly, the device may be left with a limited perspective or require the implementation of additional sensors, which can be costly.

### SUMMARY

In one embodiment, example systems and methods relate to determining motion from images using monocular depth estimation. As noted previously, perception of a surrounding environment is important in relation to navigating a device through the environment, providing monitoring of the environment, and other tasks. In general, the perception of the environment relies on a combination of multiple different types of sensors to acquire a comprehensive set of information. The system may then fuse these separate data elements together in order to provide the comprehensive information. However, a device may not always include all of the different types of sensors to acquire such information and, moreover, including such sensors is generally costly. Thus, tradeoffs between cost and capabilities are generally necessary. Accordingly, in at least one arrangement, a motion system is disclosed that implements a novel approach to deriving motion information from images and, thereby avoiding the need to implement additional sensors, such as radar.

For example, in one approach, the motion system initially acquires the images without acquiring any additional modalities of information. That is, the motion system operates on images alone as an initial input and does not use LiDAR, radar, or other sensors. The motion system processes the images using a depth model that performs monocular depth estimation. The output of the depth model is a depth map for each separate image. The depth map provides a pixel-wise estimation of depths depicted in an image. Thus, the depth map intrinsically encodes positional information about locations of objects in a scene. As such, the motion system can then use the depth maps to derive motion information. The motion information can include general indications of motion, such as a direction in which an object is moving, or, in further arrangements, the motion information may provide an explicit vector indicating direction and speed.

In any case, the motion system processes the depth maps using either a machine learning model or a heuristic to determine the motion information. In the case of the heuristic, the motion system directly compares the depth maps to identify when a particular object moves in distance. This process may be further refined through the use of object identification from a semantic model that provides for isolating locations of objects in the scene that can be tracked between separate depth maps. In the case of the machine learning model, the motion system implements a motion model that accepts the depth maps as input. The motion model processes the depth maps and can, for example, remove noise and correlate motion between the depth maps with particular objects. Thus, the motion model may output indicators of motion within the scene corresponding to separate objects therein.

Furthermore, either approach may function in the context of a static camera or a dynamic camera (i.e., a camera on a moving platform, such as a vehicle). In the case of a dynamic camera, the motion system may compensate for the motion of the camera using, for example, a transformation between poses of separate images. Thus, the motion system may use the transformation to adjust information about objects depicted in subsequent depth maps in order to permit the camera to be in motion and still accurately account for the motion of objects. In this way, the motion system permits the determination of additional information about the scene without requiring additional sensor modalities.

In one embodiment, a motion system is disclosed. The motion system includes one or more processors and a memory communicably coupled to the one or more processors. The memory stores instructions that, when executed by the one or more processors, cause the one or more processors to acquire images depicting surrounding objects present in an environment. The instructions include instructions to generate depth maps for the images according to a depth model that performs monocular depth estimation. The instructions include instructions to generate an indicator about motion associated with the surrounding objects according to the depth maps. The instructions include instructions to provide the indicator about motion.

In one embodiment, a non-transitory computer-readable medium including instructions that, when executed by one or more processors, cause the one or more processors to perform various functions is disclosed. The instructions include instructions to acquire images depicting surrounding objects present in an environment. The instructions include instructions to generate depth maps for the images according to a depth model that performs monocular depth estimation. The instructions include instructions to generate an indicator about motion associated with the surrounding objects according to the depth maps. The instructions include instructions to provide the indicator about motion.

In one embodiment, a method is disclosed. In one embodiment, the method includes acquiring images depicting surrounding objects present in an environment. The method includes generating depth maps for the images according to a depth model that performs monocular depth estimation. The method includes generating an indicator about motion associated with the surrounding objects according to the depth maps. The method includes providing the indicator about motion.

### BRIEF DESCRIPTION OF THE DRAWINGS

The accompanying drawings, which are incorporated in and constitute a part of the specification, illustrate various systems, methods, and other embodiments of the disclosure. It will be appreciated that the illustrated element boundaries (e.g., boxes, groups of boxes, or other shapes) in the figures represent one embodiment of the boundaries. In some embodiments, one element may be designed as multiple elements or multiple elements may be designed as one element. In some embodiments, an element shown as an internal component of another element may be implemented as an external component and vice versa. Furthermore, elements may not be drawn to scale.

FIG. 1 illustrates one embodiment of a vehicle within which systems and methods disclosed herein may be implemented.

FIG. 2 illustrates one embodiment of a motion system that is associated with determining motion in a scene using images and associated depth maps.

FIG. 3 illustrates one embodiment of a depth model that infers depth from a monocular image.

FIG. 4 illustrates a motion pipeline implemented by a motion system.

FIG. 5 is a flowchart illustrating one embodiment of a method for adapting a depth model according to a scaling factor.

### DETAILED DESCRIPTION

Systems, methods, and other embodiments associated with determining motion from images using monocular depth estimation. As noted previously, perception of a surrounding environment is important in relation to navigating a device through the environment, providing monitoring of the environment, and other tasks. In general, the perception of the environment relies on a combination of multiple different types of sensors to acquire a comprehensive set of information. The system may then fuse these separate data elements together in order to provide the comprehensive information. However, a device may not always include all of the different types of sensors to acquire such information, and, moreover, including such sensors is generally costly. Thus, tradeoffs between cost and capabilities are generally necessary. Accordingly, in at least one arrangement, a motion system is disclosed that implements a novel approach to deriving motion information from images and, thereby, avoiding the need to implement additional sensors, such as radar.

For example, in one approach, the motion system initially acquires the images without acquiring any additional modalities of information. That is, the motion system operates on images alone as an initial input and does not use LiDAR, radar, or other sensors. The motion system processes the images using a depth model that performs monocular depth estimation. The output of the depth model is a depth map for each separate image. The depth map provides a pixel-wise estimation of depths depicted in an image. Thus, the depth map intrinsically encodes positional information about locations of objects in a scene. As such, the motion system can then use the depth maps to derive motion information. The motion information can include general indications of motion, such as a direction in which an object is moving, or, in further arrangements, the motion information may provide an explicit vector indicating direction and speed.

In any case, the motion system processes the depth maps using either a machine learning model or a heuristic to determine the motion information. In the case of the heuristic, the motion system directly compares the depth maps to identify when a particular object moves in distance. This process may be further refined through the use of object identification from a semantic model that provides for isolating locations of objects in the scene that can be tracked between separate depth maps. In the case of the machine learning model, the motion system implements a motion model that accepts the depth maps as input. The motion model processes the depth maps and can, for example, remove noise and correlate motion between the depth maps with particular objects. Thus, the motion model may output indicators of motion within the scene corresponding to separate objects therein.

Furthermore, either approach may function in the context of a static camera or a dynamic camera (i.e., a camera on a moving platform, such as a vehicle). In the case of a dynamic camera, the motion system may compensate for the motion of the camera using, for example, a transformation between poses separate images. Thus, the motion system may use the transformation to adjust information about objects depicted in subsequent depth maps in order to permit the camera to be in motion and still accurately account for motion of objects. In this way, the motion system permits the determination of additional information about the scene without requiring additional sensor modalities.

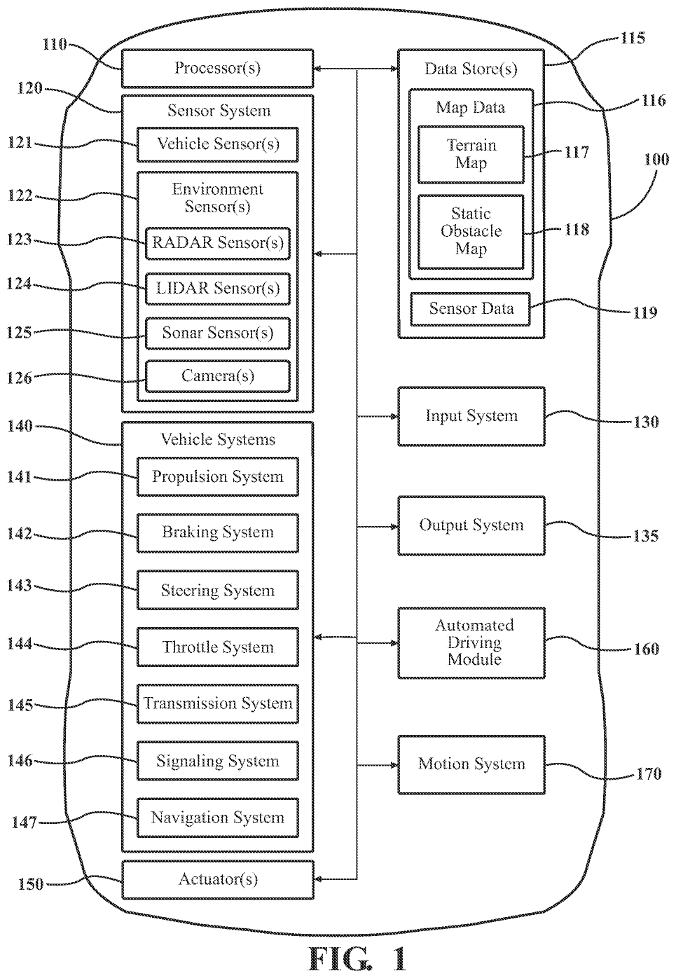

Referring to FIG. 1, an example of a vehicle 100 is illustrated. As used herein, a “vehicle” is any form of powered transport. In one or more implementations, the vehicle 100 is an automobile. While arrangements will be described herein with respect to automobiles, it will be understood that embodiments are not limited to automobiles. In some implementations, the vehicle 100 may be any electronic device (e.g., smartphone, surveillance camera, robot, static roadside unit (RSU), etc.) that, for example, perceives an environment according to monocular images, and thus benefits from the functionality discussed herein. In yet further embodiments, the vehicle 100 may instead be a statically mounted device, an embedded device, or another device that uses monocular images to derive depth information about a scene or that separately trains the depth model for deployment in such a device.

In any case, the vehicle 100 (or another electronic device) also includes various elements. It will be understood that, in various embodiments, it may not be necessary for the vehicle 100 to have all of the elements shown in FIG. 1. The vehicle 100 can have a different combination of the various elements shown in FIG. 1. Further, the vehicle 100 can have additional elements to those shown in FIG. 1. In some arrangements, the vehicle 100 may be implemented without one or more of the elements shown in FIG. 1. While the various elements are illustrated as being located within the vehicle 100, it will be understood that one or more of these elements can be located external to the vehicle 100. Further, the elements shown may be physically separated by large distances and provided as remote services (e.g., cloud-computing services, software-as-a-service (SaaS), distributed computing service, etc.).

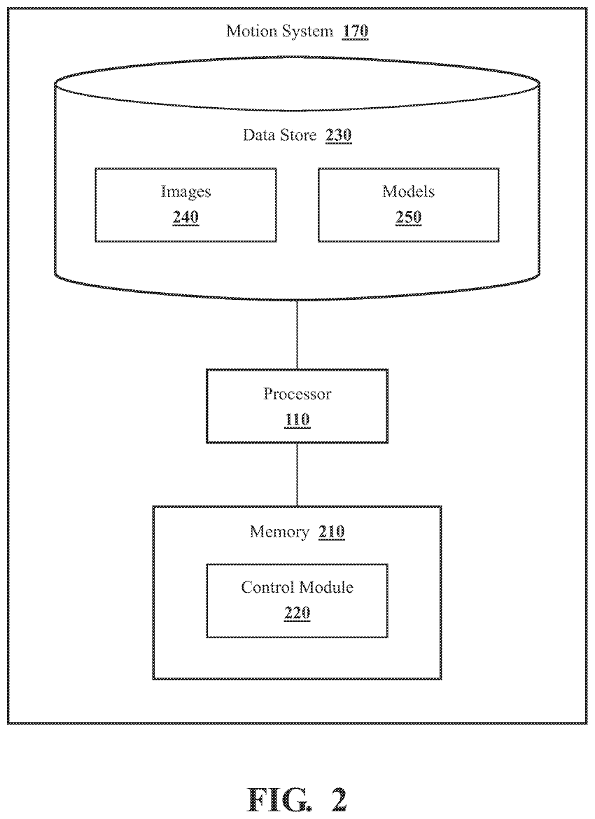

Some of the possible elements of the vehicle 100 are shown in FIG. 1 and will be described along with subsequent figures. However, a description of many of the elements in FIG. 1 will be provided after the discussion of FIGS. 2-5 for purposes of the brevity of this description. Additionally, it will be appreciated that for simplicity and clarity of illustration, where appropriate, reference numerals have been repeated among the different figures to indicate corresponding or analogous elements. In addition, the discussion outlines numerous specific details to provide a thorough understanding of the embodiments described herein. Those of skill in the art, however, will understand that the embodiments described herein may be practiced using various combinations of these elements.

In any case, the vehicle 100 includes a motion system 170 that functions to train and implement a model to process monocular images and provide determinations about motion therefrom. Moreover, while depicted as a standalone component, in one or more embodiments, the motion system 170 is integrated with the automated driving module 160, the camera 126, or another component of the vehicle 100. The noted functions and methods will become more apparent with a further discussion of the figures.

With reference to FIG. 2, one embodiment of the motion system 170 is further illustrated. The motion system 170 is shown as including a processor 110. Accordingly, the processor 110 may be a part of the motion system 170 or the motion system 170 may access the processor 110 through a data bus or another communication path. In one or more embodiments, the processor 110 is an application-specific integrated circuit (ASIC) that is configured to implement functions associated with a control module 220. In general, the processor 110 is an electronic processor, such as a microprocessor, that is capable of performing various functions, as described herein. In one embodiment, the motion system 170 includes a memory 210 that stores the control module 220. The memory 210 is a random-access memory (RAM), read-only memory (ROM), a hard disk drive, a flash memory, or other suitable memory for storing the control module 220. The control module 220 is, for example, computer-readable instructions that, when executed by the processor 110, cause the processor 110 to perform the various functions disclosed herein.

Furthermore, in one embodiment, the motion system 170 includes a data store 230. The data store 230 is, in one embodiment, an electronic data structure, such as a database, that is stored in the memory 210 or another memory, and that is configured with routines that can be executed by the processor 110 for analyzing stored data, providing stored data, organizing stored data, and so on. Thus, in one embodiment, the data store 230 stores data used by the control module 220 in executing various functions. In one embodiment, the data store 230 includes images 240, and models 250, which may include a depth model, a pose model, and/or a semantic model, along with, for example, other information that is used by the control module 220.

It should be noted that the present approach of determining motion using depth maps is generally focused on inference/implementation as opposed to training the models 250. That is, the various routines described herein generally presume that the models 250 have been previously trained for the noted tasks. In any case, the unique nature of the depth model should be appreciated in that the depth model implements monocular depth estimation and may train according to a self-supervised approach.

Accordingly, training data used by the motion system 170 generally includes one or more monocular videos that are comprised of a plurality of frames in the form of the images that are monocular images and have a corresponding character to images 240 that are acquired during inference. As described herein, a monocular image is, for example, an image from the camera 126, or another monocular camera, that may be part of a video, and that encompasses a field-of-view (FOV) about the vehicle 100 of at least a portion of the surrounding environment. That is, the monocular image is, in one approach, generally limited to a subregion of the surrounding environment. As such, the image may be of a forward-facing (i.e., the direction of travel) 60, 90, 120-degree fOV, a rear/side facing FOV, or some other subregion as defined by the characteristics of the camera 126.

In any case, the monocular image itself includes visual data of the FOV that is encoded according to a video/image standard (e.g., codec) associated with the camera 126. In general, the characteristics of the camera 126 and a video/image standard define a format of the monocular image. Thus, while the particular characteristics can vary according to different implementations, in general, the image has a defined resolution (i.e., height and width in pixels) and format. Thus, for example, the monocular image is generally an RGB visible light image. Whichever format that the motion system 170 implements, the images 240 are monocular images in that there is no explicit additional modality indicating depth nor an explicit corresponding image from another camera from which the depth can be derived (i.e., no stereo camera pair). In contrast to a stereo image that may integrate left and right images from separate cameras mounted to generate an overlapping FOV to provide an additional depth channel, the monocular image does not include explicit depth information, such as disparity maps derived from comparing the stereo images pixel-by-pixel. Instead, the monocular image implicitly provides depth information in the relationships of perspective and size of elements depicted therein from which the depth model derives the depth maps.

Moreover, the monocular video may include observations of many different scenes. That is, as the camera 126 or another original source camera of the video progresses through an environment, perspectives of objects and features in the environment change, and the depicted objects/features themselves also change, thereby depicting separate scenes (i.e., particular combinations of objects/features). Thus, the motion system 170 may extract particular training sets (e.g., pairs of source and target images) of monocular images from the monocular video for training. In particular, the motion system 170 generates the sets of images from the video so that the sets of images are of the same scene are related through the depiction of the same scene.

While images for training are generally described, the motion system 170 similarly processes images of the same/similar character after training and during inference to generate the noted outputs (i.e., the depth maps). Thus, during inference and while in use as implemented, the images 240 are instead derived from a monocular camera and may or may not be associated via a video. Additionally, while the depth model generates a single depth map per image, a pose model accepts inputs of multiple images (e.g., two or more) to produce outputs (i.e., a transformation between image views). As discussed further subsequently, the pose model generates the transformation, in one approach, to account for motion of the camera and the pose model may be trained in combination with the depth model during self-supervised structure-from-motion (SfM)-based training.

With further reference to FIG. 2, the motion system 170 further includes the models 250, which include the depth model that produces the depth maps, and, in at least one approach, the pose model, which produces transformations of camera pose between the images 240 (i.e., between an original image and a subsequent image). The pose model functions to facilitate training of the depth model and also adjustment for any motion of the camera. As previously noted, the models 250 may further include a semantic model. The semantic model, the depth model, and the pose model are, in one embodiment, machine learning algorithms. However, the particular form of the models 250 may be generally distinct. That is, for example, the depth model is a machine learning algorithm that accepts an electronic input in the form of a single monocular image and produces a depth map as a result of processing the monocular image. The exact form of the depth model may vary according to the implementation, but is generally a convolutional encoder-decoder type of neural network. In various approaches, the encoder of the depth model may serve as a backbone for all of the models 250 with each separate model having a distinct head accepting an output of the encoder.

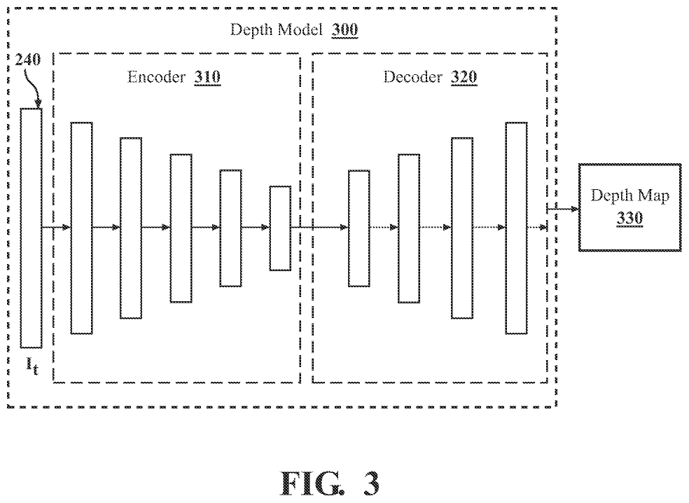

As an additional explanation of one embodiment of the depth model, consider FIG. 3. FIG. 3 illustrates a detailed view of a depth model 300. In one embodiment, the depth model 300 has an encoder/decoder architecture. The encoder/decoder architecture generally includes a set of neural network layers, including convolutional components embodied as an encoder 310 (e.g., 2D and/or 3D convolutional layers forming an encoder) that flow into deconvolutional components embodied as a decoder 320 (e.g., 2D and/or 3D deconvolutional layers forming a decoder). In one approach, the encoder 310 accepts one of the images 240 at a time as an electronic input and processes the image to extract features therefrom. The features are, in general, aspects of the image that are indicative of spatial information that the image intrinsically encodes. As such, encoding layers that form the encoder function to, for example, fold (i.e., adapt dimensions of the feature map to retain the features) encoded features into separate channels, iteratively reducing spatial dimensions of the image while packing additional channels with information about embedded states of the features. Thus, the addition of the extra channels avoids the lossy nature of the encoding process and facilitates the preservation of more information (e.g., feature details) about the original monocular image.

Accordingly, in one embodiment, the encoder 310 is comprised of multiple encoding layers formed from a combination of two-dimensional (2D) convolutional layers, packing blocks, and residual blocks. Moreover, the separate encoding layers generate outputs in the form of encoded feature maps (also referred to as tensors), which the encoding layers provide to subsequent layers in the depth model 300. As such, the encoder 310 includes a variety of separate layers that operate on the monocular image, and subsequently on derived/intermediate feature maps that convert the visual information of the monocular image into embedded state information in the form of encoded features of different channels.

In one embodiment, the decoder 320 unfolds (i.e., adapts dimensions of the tensor to extract the features) the previously encoded spatial information in order to derive the depth map 330 for a given image according to learned correlations associated with the encoded features. That is, the decoding layers generally function to up-sample, through sub-pixel convolutions and/or other mechanisms, the previously encoded features into the depth map 330, which may be provided at different resolutions. In one embodiment, the decoding layers comprise unpacking blocks, two-dimensional convolutional layers, and inverse depth layers that function as output layers for different scales of the feature map. The depth map 330 is, in one embodiment, a data structure corresponding to the input image that indicates distances/depths to objects/features represented therein. Additionally, in one embodiment, the depth map 330 is a tensor with separate data values indicating depths for corresponding locations in the image on a per-pixel basis.

Moreover, the depth model 300 can further include skip connections for providing residual information between the encoder 310 and the decoder 320 to facilitate memory of higher-level features between the separate components. While a particular encoder/decoder architecture is discussed, as previously noted, the depth model 300, in various approaches, may take different forms and generally functions to process the monocular images and provide depth maps that are per-pixel estimates about distances of objects/features depicted in the images.

Moreover, in one or more arrangements, the motion system 170 further includes a semantic model for extracting semantic information from the images 240. For example, the semantic model is a convolutional neural network (CNN) that processes the images 240 to identify a semantic representation for each pixel depicted therein. The semantic representation includes at least a classification of a type of the object and may further include additional information, such as further identifying details (e.g., vehicle make, model, year, etc.) of the object. The models 250 may further include a pose model. The pose model accepts two monocular images (i.e., a source image and a target image) of the same scene as an electronic input and processes the monocular images (Ir, Is) to produce estimates of camera ego-motion in the form of a set of 6 degree-of-freedom (DOF) transformations between the two images. The pose model itself is, for example, a convolutional neural network (CNN) or another learning model that is differentiable and performs a dimensional reduction of the input images to produce the transformation. In one arrangement, the pose model includes 7 stride-2 convolutions, a 1×1 convolution with 6*(N−1) output channels corresponding to 3 Euler angles and a 3-D translation for one of the images (source image Is), and global average pooling to aggregate predictions at all spatial locations. The transformation is, in one embodiment, a 6 DOF rigid-body transformation belonging to the special Euclidean group SE(3) that represents the change in pose between the pair of images provided as inputs to the depth model 300. In any case, the pose model performs a dimensional reduction of the monocular images to derive the transformation therefrom.

As an additional note, while the models 250 are discussed as discrete units separate from the control module 220, the models 250 are, in one or more arrangements, generally integrated with the control module 220. That is, the control module 220 functions to execute various processes of the models 250 and use various data structures of the models 250 in support of such execution. Accordingly, in one embodiment, the control module 220 includes instructions that function to control the processor 110 to generate the outputs using the models 250.

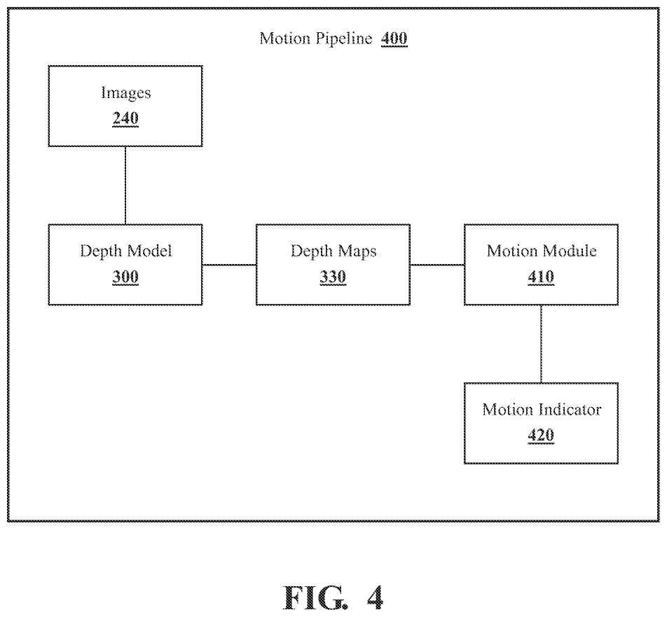

As a brief example of a motion pipeline 400 implemented with the models 250, consider FIG. 4. FIG. 4 is illustrated from the perspective of using the depth model 300 for inference to generate depth maps from which motion is derived. As shown, the depth model 300 receives the images 240 as an input. As noted previously, the depth model 300 processes one image at a time and, in general, the images 240 are processed in sequence. Thus, the depth model 300 produces the depth maps 330 that provide a sequential representation of depths within the surrounding scene. Logic embodied as the motion module 410 in the motion pipeline 400 receives the depth maps 330 and, in one approach, compares sequences of the depth maps 330 to identify motion. That is, the motion module 410 performs a direct pixel-to-pixel comparison to identify whether depth values are changing. Where the depth values increase or decrease, the motion module 410 provides the motion indicator 420 identifying the motion and the location.

Of course, in further arrangements, the motion module 410 may provide more complex analysis of the depth maps 330 to identify motion. For example, the motion module 410 may implement the semantic model to identify objects the images 240, correlate the depth values with the objects, and assign any motion to particular objects. In yet further arrangements, the motion module 410 adapts determinations of motion according to movement of the camera itself using the pose model.

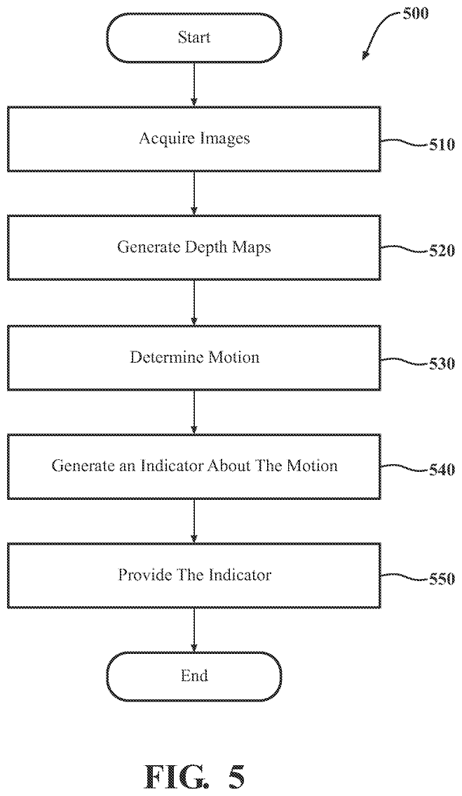

In still further arrangements, the motion module 410 implements one or more additional motion models that are trained to identify motion within depth models while also, for example, removing noise, and correlating the motion with explicit objects. The motion models may further provide an explicit determination of motion, such as a vector indicating a direction and magnitude of the motion. Specific aspects of how the motion system 170 determines the motion will be further discussed in relation to FIG. 5.

FIG. 5 illustrates a flowchart of a method 600 that is associated with using salient features to improve scale awareness in a depth model. Method 600 will be discussed from the perspective of the motion system 170. While method 600 is discussed in combination with the motion system 170, it should be appreciated that the method 600 is not limited to being implemented within the motion system 170 but is instead one example of a system that may implement the method 600.

At 510, the control module 220 acquires the images 240 depicting surrounding objects present in the environment. As previously outlined, the control module 220 acquires the images 240 from a monocular camera (e.g., camera 126) over a period of time that may be ongoing in real-time. The images 240 are monocular images having characteristics defined according to a camera and associated systems that capture the images 240. As one example, while the vehicle 100 is operating in an environment, the control module 220 is capturing the images 240, which the motion system 170 can then process according to the method 500 in order to, for example, determine aspects of the environment, such as depth, motion, and so on.

At 520, the control module 220 generates depth maps for the images 240 according to the depth model. As previously explained, the depth model performs monocular depth estimation, which generally involves deriving depth information from a monocular image without additional information about the scene. Accordingly, as the motion system 170 acquires the images 240, the control module 220 is using the depth model to also derive the depth maps. The depth maps provide per-pixel depth information corresponding with respective ones of the images 240. Thus, the motion system 170 need not have access to explicit depth information from, for example, a LiDAR, stereo camera or other device, in order to expand knowledge about the surrounding environment.

It should be noted that while the control module 220 derives the depth maps from the images 240, in various approaches, the control module 220 may also process the images 240 to derive additional information that may assist in the subsequent analysis. For example, the control module 220 may apply a semantic model that generates a semantic map of the image. The semantic map, in at least one approach, provides a pixel-wise identification of object types associated with each separate pixel. Of course, in further approaches, the semantic model may provide a coarser determination of simply identifying particular types of objects using bounding boxes, such as dynamic objects, including pedestrians, vehicles, and other objects commonly observed in motion.

At 530, the control module determines motion for surrounding objects present in the environment. As an initial point, the present disclosure envisions multiple different ways in which the motion system 170 may determine the motion. In a first approach, the control module 220 generates an indicator of motion according to a direct comparison between depth maps. For example, the control module 220 compares the depth maps on a per-pixel basis according to a heuristic. That is, the control module 220 implements logic in the form of a heuristic that compares depth values within the depth maps (i.e., two or more sequential depth maps) to identify pixels with values that have changed to indicate increasing or decreasing depths. In general, the heuristic is the coarsest approach and can be configured to provide a general indication of motion (i.e., motion at pixels (x, y)) or a finer determination of motion (i.e., a vector indicating speed and direction). Overall, the heuristic is simply identifying changes in depth at a given pixel, which indicate the occurrence of motion.

In further approaches, the control module 220 leverages the semantic information, as previously described, to assign the motion to particular objects in the environment. That is, the control module 220 may determine the depth of an object according to a correlation between semantic information (e.g., a bounding box defining a specific object) and depth values of a corresponding depth map. The control module 220 then correlates the depth values and the object in a subsequent frame and can thus compare the depths to determine motion. In yet a further aspect, the control module 220 may determine a first position in 3D space from a first depth map and determine the motion between the first position and a second position in 3D space according to a subsequent depth map. In this way, more precise information about the motion is identified without the need for additional sensor modalities, such as radar, LiDAR, etc.

In still a further arrangement, the control module 220 implements a separate model, the motion model. The motion model may vary in form depending on the particular embodiment but is generally a machine learning model that may take the form of a CNN, a transformer network, a recurrent neural network, or a combination of networks. In any case, the motion model accepts at least two depth maps as input and outputs a determination of motion in the environment.

In one example, the control module 220 trains the motion model using the previously described heuristic. Thus, the control module 220 generates the determination about the motion using the heuristic and also provides the depth maps to the motion model. The motion model generates an output specifying the presence or not of motion and information about the motion. The control module 220 can then use the determination from the heuristic as a supervising signal to train the motion model.

In further approaches, the form of the motion model may vary such that the motion model accepts additional information in order to provide a more refined determination. For example, the motion model may use the encoder of the depth model as a common backbone that encodes the images into abstracted features. The motion model may include multiple separate heads, such as a depth head (i.e., depth decoder 320), a semantic head that provides determinations about semantic classifications/objects akin to the semantic model, a pose head for correcting motion of the camera, and a motion head. In one configuration, the outputs of the various heads and the encoder may feed into the motion head, which then functions to determine the motion according to learned priors. In general, the motion head accounts for noise and other aberrations while also correlating changes in depth with particular objects depicted in the image. As such, the motion model can output a vector quantity indicating a magnitude and direction of the motion and may further output a specific location of the object. The motion system 170 can further use the motion information to, for example, provide a predicted trajectory of the object.

Lastly, the motion system 170 may further compensate for motion of the camera when determining motion derived from the depth maps. As may be applicable to either approach, determining the motion includes compensating for motion of a platform on which the camera is mounted by, for example, generating a transformation that defines a change in position between poses of the camera when capturing the images. Thus, in at least one approach, the motion system 170 implements a pose model that defines a transformation between the images. The motion system 170 can then use the transformation to adjust values of the depth maps to compensate for the motion and thereby provide accurate determinations of motion in relation to the objects in the environment themselves.

At 540, the control module 220 generates an indicator of the motion. In one approach, the indicator is simply a binary identifier of whether or not an object depicted in the images 240 is moving. In further approaches, the indicator provides identification of at least pixels associated with the motion. In still further approaches, the indicator is an explicit identification of which object is moving and may further include characteristics of the motion, such as a vector of the velocity as noted previously.

At 550, the control module 220 provides the indicator about motion. In one approach, the control module 220 provides the indicator includes associating the motion with an identified object. That is, the control module 220 may fuse the indicator with the image or other processed sensor data, thereby annotating the information with information about the motion. The control module 220 may then communicate the indicator and the associated information to other systems/modules. In one arrangement, the control module 220 provides the indicator about the motion to an automate driving module 160 that implements, for example, advanced driving assistance systems (ADAS). The module 160 can then use the information about the motion to adapt control of the vehicle 100 and/or provide various alerts to a driver to improve control by the driver. In this way, the motion system 170 functions to improve the operation of the vehicle 100 or other associated devices without implementing additional modalities of information acquisition.

FIG. 1 will now be discussed in full detail as an example environment within which the system and methods disclosed herein may operate. In some instances, the vehicle 100 is configured to switch selectively between an autonomous mode, one or more semi-autonomous operational modes, and/or a manual mode. Such switching can be implemented in a suitable manner, now known or later developed. “Manual mode” means that all of or a majority of the navigation and/or maneuvering of the vehicle is performed according to inputs received from a user (e.g., human driver). In one or more arrangements, the vehicle 100 can be a conventional vehicle that is configured to operate in only a manual mode.

In one or more embodiments, the vehicle 100 is an autonomous vehicle. As used herein, “autonomous vehicle” refers to a vehicle that operates in an autonomous mode. “Autonomous mode” refers to navigating and/or maneuvering the vehicle 100 along a travel route using one or more computing systems to control the vehicle 100 with minimal or no input from a human driver. In one or more embodiments, the vehicle 100 is highly automated or completely automated. In one embodiment, the vehicle 100 is configured with one or more semi-autonomous operational modes in which one or more computing systems perform a portion of the navigation and/or maneuvering of the vehicle along a travel route, and a vehicle operator (i.e., driver) provides inputs to the vehicle to perform a portion of the navigation and/or maneuvering of the vehicle 100 along a travel route.

The vehicle 100 can include one or more processors 110. In one or more arrangements, the processor(s) 110 can be a main processor of the vehicle 100. For instance, the processor(s) 110 can be an electronic control unit (ECU). The vehicle 100 can include one or more data stores 115 for storing one or more types of data. The data store 115 can include volatile and/or non-volatile memory. Examples of suitable data stores 115 include RAM (Random Access Memory), flash memory, ROM (Read Only Memory), PROM (Programmable Read-Only Memory), EPROM (Erasable Programmable Read-Only Memory), EEPROM (Electrically Erasable Programmable Read-Only Memory), registers, magnetic disks, optical disks, hard drives, or any other suitable storage medium, or any combination thereof. The data store 115 can be a component of the processor(s) 110, or the data store 115 can be operatively connected to the processor(s) 110 for use thereby. The term “operatively connected,” as used throughout this description, can include direct or indirect connections, including connections without direct physical contact.

In one or more arrangements, the one or more data stores 115 can include map data 116. The map data 116 can include maps of one or more geographic areas. In some instances, the map data 116 can include information or data on roads, traffic control devices, road markings, structures, features, and/or landmarks in the one or more geographic areas. The map data 116 can be in any suitable form. In some instances, the map data 116 can include aerial views of an area. In some instances, the map data 116 can include ground views of an area, including 360-degree ground views. The map data 116 can include measurements, dimensions, distances, and/or information for one or more items included in the map data 116 and/or relative to other items included in the map data 116. The map data 116 can include a digital map with information about road geometry. The map data 116 can be high quality and/or highly detailed.

In one or more arrangements, the map data 116 can include one or more terrain maps 117. The terrain map(s) 117 can include information about the ground, terrain, roads, surfaces, and/or other features of one or more geographic areas. The terrain map(s) 117 can include elevation data in the one or more geographic areas. The map data 116 can be high quality and/or highly detailed. The terrain map(s) 117 can define one or more ground surfaces, which can include paved roads, unpaved roads, land, and other things that define a ground surface.

In one or more arrangements, the map data 116 can include one or more static obstacle maps 118. The static obstacle map(s) 118 can include information about one or more static obstacles located within one or more geographic areas. A “static obstacle” is a physical object whose position does not change or substantially change over a period of time and/or whose size does not change or substantially change over a period of time. Examples of static obstacles include trees, buildings, curbs, fences, railings, medians, utility poles, statues, monuments, signs, benches, furniture, mailboxes, large rocks, hills. The static obstacles can be objects that extend above ground level. The one or more static obstacles included in the static obstacle map(s) 118 can have location data, size data, dimension data, material data, and/or other data associated with it. The static obstacle map(s) 118 can include measurements, dimensions, distances, and/or information for one or more static obstacles. The static obstacle map(s) 118 can be high quality and/or highly detailed. The static obstacle map(s) 118 can be updated to reflect changes within a mapped area.

The one or more data stores 115 can include sensor data 119. In this context, “sensor data” means any information about the sensors that the vehicle 100 is equipped with, including the capabilities and other information about such sensors. As will be explained below, the vehicle 100 can include the sensor system 120. The sensor data 119 can relate to one or more sensors of the sensor system 120. As an example, in one or more arrangements, the sensor data 119 can include information on one or more LIDAR sensors 124 of the sensor system 120.

In some instances, at least a portion of the map data 116 and/or the sensor data 119 can be located in one or more data stores 115 located onboard the vehicle 100. Alternatively, or in addition, at least a portion of the map data 116 and/or the sensor data 119 can be located in one or more data stores 115 that are located remotely from the vehicle 100.

As noted above, the vehicle 100 can include the sensor system 120. The sensor system 120 can include one or more sensors. “Sensor” means any device, component, and/or system that can detect, and/or sense something. The one or more sensors can be configured to detect, and/or sense in real-time. As used herein, the term “real-time” means a level of processing responsiveness that a user or system senses as sufficiently immediate for a particular process or determination to be made, or that enables the processor to keep up with some external process.

In arrangements in which the sensor system 120 includes a plurality of sensors, the sensors can work independently from each other. Alternatively, two or more of the sensors can work in combination with each other. In such a case, the two or more sensors can form a sensor network. The sensor system 120 and/or the one or more sensors can be operatively connected to the processor(s) 110, the data store(s) 115, and/or another element of the vehicle 100 (including any of the elements shown in FIG. 1). The sensor system 120 can acquire data of at least a portion of the external environment of the vehicle 100.

The sensor system 120 can include any suitable type of sensor. Various examples of different types of sensors will be described herein. However, it will be understood that the embodiments are not limited to the particular sensors described. The sensor system 120 can include one or more vehicle sensors 121. The vehicle sensor(s) 121 can detect, determine, and/or sense information about the vehicle 100 itself. In one or more arrangements, the vehicle sensor(s) 121 can be configured to detect, and/or sense position and orientation changes of the vehicle 100, such as, for example, based on inertial acceleration. In one or more arrangements, the vehicle sensor(s) 121 can include one or more accelerometers, one or more gyroscopes, an inertial measurement unit (IMU), a dead-reckoning system, a global navigation satellite system (GNSS), a global positioning system (GPS), a navigation system 147, and/or other suitable sensors. The vehicle sensor(s) 121 can be configured to detect, and/or sense one or more characteristics of the vehicle 100. In one or more arrangements, the vehicle sensor(s) 121 can include a speedometer to determine a current speed of the vehicle 100.

Alternatively, or in addition, the sensor system 120 can include one or more environment sensors 122 configured to acquire, and/or sense driving environment data. “Driving environment data” includes data or information about the external environment in which an autonomous vehicle is located or one or more portions thereof. For example, the one or more environment sensors 122 can be configured to detect, quantify and/or sense obstacles in at least a portion of the external environment of the vehicle 100 and/or information/data about such obstacles. Such obstacles may be stationary objects and/or dynamic objects. The one or more environment sensors 122 can be configured to detect, measure, quantify and/or sense other things in the external environment of the vehicle 100, such as, for example, lane markers, signs, traffic lights, traffic signs, lane lines, crosswalks, curbs proximate the vehicle 100, off-road objects, etc.

Various examples of sensors of the sensor system 120 will be described herein. The example sensors may be part of the one or more environment sensors 122 and/or the one or more vehicle sensors 121. However, it will be understood that the embodiments are not limited to the particular sensors described.

As an example, in one or more arrangements, the sensor system 120 can include one or more radar sensors 123, one or more LIDAR sensors 124 (e.g., 4 beam LiDAR), one or more sonar sensors 125, and/or one or more cameras 126. In one or more arrangements, the one or more cameras 126 can be high dynamic range (HDR) cameras or infrared (IR) cameras.

The vehicle 100 can include an input system 130. An “input system” includes any device, component, system, element or arrangement or groups thereof that enable information/data to be entered into a machine. The input system 130 can receive an input from a vehicle passenger (e.g., a driver or a passenger). The vehicle 100 can include an output system 135. An “output system” includes a device, or component, that enables information/data to be presented to a vehicle passenger (e.g., a person, a vehicle passenger, etc.).

The vehicle 100 can include one or more vehicle systems 140. Various examples of the one or more vehicle systems 140 are shown in FIG. 1. However, the vehicle 100 can include more, fewer, or different vehicle systems. It should be appreciated that although particular vehicle systems are separately defined, each or any of the systems or portions thereof may be otherwise combined or segregated via hardware and/or software within the vehicle 100. The vehicle 100 can include a propulsion system 141, a braking system 142, a steering system 143, throttle system 144, a transmission system 145, a signaling system 146, and/or a navigation system 147. Each of these systems can include one or more devices, components, and/or a combination thereof, now known or later developed.

The navigation system 147 can include one or more devices, applications, and/or combinations thereof, now known or later developed, configured to determine the geographic location of the vehicle 100 and/or to determine a travel route for the vehicle 100. The navigation system 147 can include one or more mapping applications to determine a travel route for the vehicle 100. The navigation system 147 can include a global positioning system, a local positioning system, or a geolocation system.

The processor(s) 110, the motion system 170, and/or the automated driving module 160 can be operatively connected to communicate with the various vehicle systems 140 and/or individual components thereof. For example, returning to FIG. 1, the processor(s) 110 and/or the automated driving module 160 can be in communication to send and/or receive information from the various vehicle systems 140 to control the movement, speed, maneuvering, heading, direction, etc. of the vehicle 100. The processor(s) 110, the motion system 170, and/or the automated driving module 160 may control some or all of these vehicle systems 140 and, thus, may be partially or fully autonomous.

The processor(s) 110, the motion system 170, and/or the automated driving module 160 can be operatively connected to communicate with the various vehicle systems 140 and/or individual components thereof. For example, returning to FIG. 1, the processor(s) 110, the motion system 170, and/or the automated driving module 160 can be in communication to send and/or receive information from the various vehicle systems 140 to control the movement, speed, maneuvering, heading, direction, etc. of the vehicle 100. The processor(s) 110, the motion system 170, and/or the automated driving module 160 may control some or all of these vehicle systems 140.

The processor(s) 110, the motion system 170, and/or the automated driving module 160 may be operable to control the navigation and/or maneuvering of the vehicle 100 by controlling one or more of the vehicle systems 140 and/or components thereof. For instance, when operating in an autonomous mode, the processor(s) 110, the motion system 170, and/or the automated driving module 160 can control the direction and/or speed of the vehicle 100. The processor(s) 110, the motion system 170, and/or the automated driving module 160 can cause the vehicle 100 to accelerate (e.g., by increasing the supply of fuel provided to the engine), decelerate (e.g., by decreasing the supply of fuel to the engine and/or by applying brakes) and/or change direction (e.g., by turning the front two wheels). As used herein, “cause” or “causing” means to make, force, compel, direct, command, instruct, and/or enable an event or action to occur or at least be in a state where such event or action may occur, either in a direct or indirect manner.

The vehicle 100 can include one or more actuators 150. The actuators 150 can be any element or combination of elements operable to modify, adjust and/or alter one or more of the vehicle systems 140 or components thereof responsive to receiving signals or other inputs from the processor(s) 110 and/or the automated driving module 160. Any suitable actuator can be used. For instance, the one or more actuators 150 can include motors, pneumatic actuators, hydraulic pistons, relays, solenoids, and/or piezoelectric actuators, just to name a few possibilities.

The vehicle 100 can include one or more modules, at least some of which are described herein. The modules can be implemented as computer-readable program code that, when executed by a processor 110, implement one or more of the various processes described herein. One or more of the modules can be a component of the processor(s) 110, or one or more of the modules can be executed on and/or distributed among other processing systems to which the processor(s) 110 is operatively connected. The modules can include instructions (e.g., program logic) executable by one or more processor(s) 110. Alternatively, or in addition, one or more data store 115 may contain such instructions.

In one or more arrangements, one or more of the modules described herein can include artificial or computational intelligence elements, e.g., neural network, fuzzy logic, or other machine learning algorithms. Further, in one or more arrangements, one or more of the modules can be distributed among a plurality of the modules described herein. In one or more arrangements, two or more of the modules described herein can be combined into a single module.

The vehicle 100 can include one or more autonomous driving modules 160. The automated driving module 160 can be configured to receive data from the sensor system 120 and/or any other type of system capable of capturing information relating to the vehicle 100 and/or the external environment of the vehicle 100. In one or more arrangements, the automated driving module 160 can use such data to generate one or more driving scene models. The automated driving module 160 can determine a position and velocity of the vehicle 100. The automated driving module 160 can determine the location of obstacles, obstacles, or other environmental features including traffic signs, trees, shrubs, neighboring vehicles, pedestrians, etc.

The automated driving module 160 can be configured to receive, and/or determine location information for obstacles within the external environment of the vehicle 100 for use by the processor(s) 110, and/or one or more of the modules described herein to estimate position and orientation of the vehicle 100, vehicle position in global coordinates based on signals from a plurality of satellites, or any other data and/or signals that could be used to determine the current state of the vehicle 100 or determine the position of the vehicle 100 with respect to its environment for use in either creating a map or determining the position of the vehicle 100 in respect to map data.

The automated driving module 160 either independently or in combination with the motion system 170 can be configured to determine travel path(s), current autonomous driving maneuvers for the vehicle 100, future autonomous driving maneuvers and/or modifications to current autonomous driving maneuvers based on data acquired by the sensor system 120, driving scene models, and/or data from any other suitable source. “Driving maneuver” means one or more actions that affect the movement of a vehicle. Examples of driving maneuvers include: accelerating, decelerating, braking, turning, moving in a lateral direction of the vehicle 100, changing travel lanes, merging into a travel lane, and/or reversing, just to name a few possibilities. The automated driving module 160 can be configured to implement determined driving maneuvers. The automated driving module 160 can cause, directly or indirectly, such autonomous driving maneuvers to be implemented. As used herein, “cause” or “causing” means to make, command, instruct, and/or enable an event or action to occur or at least be in a state where such event or action may occur, either in a direct or indirect manner. The automated driving module 160 can be configured to execute various vehicle functions and/or to transmit data to, receive data from, interact with, and/or control the vehicle 100 or one or more systems thereof (e.g., one or more of vehicle systems 140).

Detailed embodiments are disclosed herein. However, it is to be understood that the disclosed embodiments are intended only as examples. Therefore, specific structural and functional details disclosed herein are not to be interpreted as limiting, but merely as a basis for the claims and as a representative basis for teaching one skilled in the art to variously employ the aspects herein in virtually any appropriately detailed structure. Further, the terms and phrases used herein are not intended to be limiting but rather to provide an understandable description of possible implementations. Various embodiments are shown in FIGS. 1-5, but the embodiments are not limited to the illustrated structure or application.

The flowcharts and block diagrams in the Figures illustrate the architecture, functionality, and operation of possible implementations of systems, methods, and computer program products according to various embodiments. In this regard, each block in the flowcharts or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved.

The systems, components and/or processes described above can be realized in hardware or a combination of hardware and software and can be realized in a centralized fashion in one processing system or in a distributed fashion where different elements are spread across several interconnected processing systems. Any kind of processing system or another apparatus adapted for carrying out the methods described herein is suited. A typical combination of hardware and software can be a processing system with computer-usable program code that, when being loaded and executed, controls the processing system such that it carries out the methods described herein. The systems, components and/or processes also can be embedded in a computer-readable storage, such as a computer program product or other data programs storage device, readable by a machine, tangibly embodying a program of instructions executable by the machine to perform methods and processes described herein. These elements also can be embedded in an application product which comprises all the features enabling the implementation of the methods described herein and, which when loaded in a processing system, is able to carry out these methods.

Furthermore, arrangements described herein may take the form of a computer program product embodied in one or more computer-readable media having computer-readable program code embodied, e.g., stored, thereon. Any combination of one or more computer-readable media may be utilized. The computer-readable medium may be a computer-readable signal medium or a computer-readable storage medium. The phrase “computer-readable storage medium” means a non-transitory storage medium. A computer-readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer-readable storage medium would include the following: a portable computer diskette, a hard disk drive (HDD), a solid-state drive (SSD), a read-only memory (ROM), an erasable programmable read-only memory (EPROM or Flash memory), a portable compact disc read-only memory (CD-ROM), a digital versatile disc (DVD), an optical storage device, a magnetic storage device, or any suitable combination of the foregoing. In the context of this document, a computer-readable storage medium may be any tangible medium that can contain, or store a program for use by or in connection with an instruction execution system, apparatus, or device.

Generally, module, as used herein, includes routines, programs, objects, components, data structures, and so on that perform particular tasks or implement particular data types. In further aspects, a memory generally stores the noted modules. The memory associated with a module may be a buffer or cache embedded within a processor, a RAM, a ROM, a flash memory, or another suitable electronic storage medium. In still further aspects, a module as envisioned by the present disclosure is implemented as an application-specific integrated circuit (ASIC), a hardware component of a system on a chip (SoC), as a programmable logic array (PLA), or as another suitable hardware component that is embedded with a defined configuration set (e.g., instructions) for performing the disclosed functions.

Program code embodied on a computer-readable medium may be transmitted using any appropriate medium, including but not limited to wireless, wireline, optical fiber, cable, RF, etc., or any suitable combination of the foregoing. Computer program code for carrying out operations for aspects of the present arrangements may be written in any combination of one or more programming languages, including an object-oriented programming language such as Java™ Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer, or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

The terms “a” and “an,” as used herein, are defined as one or more than one. The term “plurality,” as used herein, is defined as two or more than two. The term “another,” as used herein, is defined as at least a second or more. The terms “including” and/or “having,” as used herein, are defined as comprising (i.e., open language). The phrase “at least one of . . . and . . . ” as used herein refers to and encompasses any and all possible combinations of one or more of the associated listed items. As an example, the phrase “at least one of A, B, and C” includes A only, B only, C only, or any combination thereof (e.g., AB, AC, BC or ABC).

Aspects herein can be embodied in other forms without departing from the spirit or essential attributes thereof. Accordingly, reference should be made to the following claims, rather than to the foregoing specification, as indicating the scope hereof.

What is claimed is:

1. A motion system, comprising:
one or more processors;
a memory communicably coupled to the one or more processors and storing instructions that, when executed by the one or more processors, cause the one or more processors to:
acquire images depicting surrounding objects present in an environment;
generate depth maps for the images according to a depth model that performs monocular depth estimation;
generate an indicator about motion associated with the surrounding objects according to the depth maps; and
provide the indicator about motion.

2. The motion system of claim 1, wherein the instructions to generate the indicator include instructions to compare the depth maps on a per-pixel basis according to a heuristic.

3. The motion system of claim 2, wherein the instructions to generate the indicator include instructions to generate the indicator according to the heuristic that compares depth values within the depth maps to identify pixels with values that have changed to indicate increasing or decreasing depths.

4. The motion system of claim 1, wherein the instructions to generate the indicator include instructions to apply a motion model that is a machine learning model to the depth maps to identify a presence and a location of motion in the images.

5. The motion system of claim 4, wherein the instructions further include instructions to:
train the motion model using a heuristic to generate supervising annotations for the depth maps by comparing the depth maps to directly identify motion.

6. The motion system of claim 1, wherein the instructions to generate the indicator include instructions to compensate for motion of a platform on which a camera is mounted by generating a transformation that defines a change in position between poses of the camera when capturing the images.

7. The motion system of claim 1, wherein the instructions to provide the indicator include instructions to associate the motion with an identified object of the surrounding objects according to a semantic model that identifies the surrounding objects and a pixel-wise association of the motion in relation to the identified object.

8. The motion system of claim 1, wherein the depth model performs monocular depth estimation and is trained according to self-supervised structure-from-motion (SfM) training.

9. A non-transitory computer-readable medium including instructions that, when executed by one or more processors, cause the one or more processors to:
acquire images depicting surrounding objects present in an environment;
generate depth maps for the images according to a depth model that performs monocular depth estimation;
generate an indicator about motion associated with the surrounding objects according to the depth maps; and
provide the indicator about motion.

10. The non-transitory computer-readable medium of claim 9, wherein the instructions to generate the indicator include instructions to compare the depth maps on a per-pixel basis according to a heuristic.

11. The non-transitory computer-readable medium of claim 10, wherein the instructions to generate the indicator include instructions to generate the indicator according to the heuristic that compares depth values within the depth maps to identify pixels with values that have changed to indicate increasing or decreasing depths.

12. The non-transitory computer-readable medium of claim 9, wherein the instructions to generate the indicator include instructions to apply a motion model that is a machine learning model to the depth maps to identify a presence and a location of motion in the images.

13. The non-transitory computer-readable medium of claim 12, wherein the instructions further include instructions to:
train the motion model using a heuristic to generate supervising annotations for the depth maps by comparing the depth maps to directly identify motion.

14. A method, comprising:
acquiring images depicting surrounding objects present in an environment;
generating depth maps for the images according to a depth model that performs monocular depth estimation;
generating an indicator about motion associated with the surrounding objects according to the depth maps; and
providing the indicator about motion.

15. The method of claim 14, wherein generating the indicator includes comparing the depth maps on a per-pixel basis according to a heuristic.

16. The method of claim 15, wherein the heuristic compares depth values within the depth maps to identify pixels with values that have changed to indicate increasing or decreasing depths.

17. The method of claim 14, wherein generating the indicator includes applying a motion model that is a machine learning model to the depth maps to identify a presence and a location of motion in the images.

18. The method of claim 17, further comprising:
training the motion model using a heuristic to generate supervising annotations for the depth maps by comparing the depth maps to directly identify motion.

19. The method of claim 14, wherein generating the indicator includes compensating for motion of a platform on which a camera is mounted by generating a transformation that defines a change in position between poses of the camera when capturing the images.

20. The method of claim 14, wherein providing the indicator includes associating the motion with an identified object of the surrounding objects according to a semantic model that identifies the surrounding objects and a pixel-wise association of the motion in relation to the identified object, and
wherein the depth model performs monocular depth estimation and is trained according to self-supervised structure-from-motion (SfM) training.
